(19) United States
(12) Patent Application Publication
(10) Pub. No.: US 2003/0200844 A1
(43) Pub. Date: Oct. 30, 2003

(54) Coated CBN polycrystalline superabrasive tools

(76) Inventors: William E. Jackson, Cleveland, OH (US); John W. Lucek, Powell, OH (US)

Correspondence Address: Hanh T. Pham, General Electric Company, One Plastics Avenue, Pittsfield, MA, 01201, US

(21) Appl. No.: 10/411,471

(22) Filed: Apr. 8, 2003

Related U.S. Application Data
(63) Continuation-in-part of application No. 08/779,417, filed on Jan. 7, 1997, now abandoned.

(51) Int. Cl. B23B 3/28

(52) U.S. Cl. 82/11.1

(57) ABSTRACT

A polycrystalline cubic boron nitride (cBN) cutting tool contains less than 70 volume-% cBN and is coated with a layer of hard refractory material. Appropriate hard refractory coating materials possess characteristics, which include that such material:

(a) forms a stable chemical bond (e.g., a nitride or boride) with cBN,

(b) is inert to ferrous metals,

(c) will not promote back-conversion of cBN, and

(d) will form a continuous coating on cBN under conditions which are not detrimental to cBN.

Materials that exhibit such characteristics broadly include, for example, a boride, carbide, nitride, or silicide of a metal. Representative of such materials are, for example, the borides of Ti, Zr, V, Ta, Cr; the carbides of Zr, V; the nitrides of Cr, Ta, Si, Al; and the suicides of Mo.

### CROSS-REFERENCE TO RELATED APPLICATIONS

This application is a continuation-in-part of application Ser. No. 08/779,417, filed Jan. 7, 1997, the disclosure of which is expressly incorporated herein by reference.

### STATEMENT REGARDING FEDERALLY SPONSORED RESEARCH

Not applicable.

### BACKGROUND OF THE INVENTION

The present invention relates to cutting, milling, and turning tools and more particularly to improving the performance of cubic boron nitride (cBN) superabrasive tools for material removal operations.

The manufacture of cBN by the high pressure/high temperature (HP/HT) process is known in the art and is typified by the process described in U.S. Pat. No. 2,947,617, a basic monocrystalline cBN case. U.S. Pat. No. 4,188,194 describes a process for making sintered polycrystalline cBN compacts, which utilizes pyrolytic hexagonal boron nitride (PBN) in the absence of any catalyst. An improvement on such direct conversion process is disclosed in U.S. Pat. No. 4,289,503 wherein boric oxide is removed from the surface of the HBN powder before the conversion process.

A compact is a mass of abrasive particles bonded together in a self-bonded relationship (see U.S. Pat. Nos. 3,852,078 and 3,876,751); by means of a bonding medium (U.S. Pat. Nos. 3,136,615, 3,233,988, 3,743,489, 3,767,371, and 3,918,931); or by means of combinations thereof. A composite compact is a compact bonded to a substrate material, such as cemented metal carbide. U.S. Pat. No. 3,918,219 teaches the catalytic conversion of hexagonal boron nitride (HBN) to cBN in contact with a carbide mass to form a composite cBN compact. Compacts or composite compacts may be used in blanks for cutting tools, drill bits, dressing tools, and wear parts (see U.S. Pat. Nos. 3,136,615 and 3,233,988).

Polycrystalline cBN compacts often are used in machining ferrous alloy workpieces. The mechanical and chemical properties of the tool generally are optimized for performance with classes of alloys and machining conditions. High cBN content compacts, over 70 volume percent cBN, provide the highest hardness, but, generally, are reactive towards alloy steels. To improve utility, non-reactive phases often are added to reduce the cBN compact's ability to react with ferrous alloys. While some improvements have been realized by this approach, an optimized product is required for each chemical class of alloy materials to be machined. A more universal solution is needed.

### BRIEF SUMMARY OF THE INVENTION

A polycrystalline cubic boron nitride (cBN) cutting tool contains less than 70 volume-% cBN and is coated with a layer of hard refractory material. Appropriate hard refractory coating materials possess characteristics, which include that such material:

(a) forms a stable chemical bond (e.g., a nitride or boride) with cBN,

(b) is inert to ferrous metals,

(c) will not promote back-conversion of cBN, and

(d) will form a continuous coating on cBN under conditions which are not detrimental to cBN.

Materials that exhibit such characteristics broadly include, for example, a boride, carbide, nitride, or silicide of a metal. Representative of such materials are, for example, the borides of Ti, Zr, V, Ta, Cr; the carbides of Zr, V; the nitrides of Cr, Ta, Si, Al; and the silicides of Mo.

Advantages of the present invention include the ability to extend the useful life of cBN cutting tools by providing the rigidity and bulk hardness of cBN, and the chemical inertness of a ceramic phase at the tool/workpiece interface. Another advantage is that the inventive cBN cutting tools show such improvement regardless of the type of ferrous alloy being machined. Yet another advantage is that application of the coatings to the cBN cutting tools is a relatively simple commercial operation. These and other advantages will become readily apparent to those skilled in the art based upon the instant disclosure.

### BRIEF DESCRIPTION OF THE DRAWINGS

FIGS. 1-4 depict graphically the test results summarized in Tables I-IV. They will be described in detail below in the Examples.

### DETAILED DESCRIPTION OF THE INVENTION

While coating cBN compacts with over 70 volume % cBN, as proposed in EP 102,843, would seem to hold promise in possibly improving the cutting performance of such compacts, such products have yet to enter the marketplace. During work on the present invention, modest cutting performance improvement of coated high cBN-containing compacts. was confirmed. It was unexpectedly discovered, however, that cBN compacts with less than 70 volume-% cBN content showed dramatic improvement in such machining operations, notably a longer useful life. Such improvement in machining performance is seen for cBN compacts that contain greater than 30 volume-% second phase, typically a ceramic material like TiN or TiC as is conventional in this art field. Moreover, the tool lives of coated low cBN content compacts were several times as long as the coated high cBN content compacts described in the prior art. The coatings providing improved tool life for <70 volume-% cBN compacts exhibit certain characteristics as set forth below:

(a) forms a stable chemical bond (e.g., a nitride or boride) with cBN,

(b) is inert to ferrous metals,

(c) will not promote back-conversion of cBN, and

(d) will form a continuous coating on cBN under conditions which are not detrimental to cBN.

Materials that exhibit such characteristics broadly include, for example, a boride, carbide, nitride, or silicide of a metal. Representative of such materials are, for example, the borides of Ti, Zr, V, Ta, Cr; the carbides of Zr, Ti, V; the nitrides of Cr, Ta, Ti, Si, Al; and the silicides of Mo. Of these materials, TiN has proven quite efficacious. TiC, despite citations in prior art for high cBN content materials, unexpectedly has proven of less value for the samples tested, as the examples will demonstrate.

Refractory coatings can be applied by a variety of conventional techniques including, for example, chemical vapor deposition, plasma activated vapor deposition, sputtering techniques, and vacuum plating. Such techniques are well known in the art and little more need stated about them.

Coating thicknesses should be effective in extending the useful life of the cBN compact. Broadly, the performance of the coated compacts should be at least about as good as a high (e.g., >70% cBN content) cBN compact and typically the performance of the inventive coated cBN compacts should exceed the performance of high cBN compacts for certain workpieces. This performance enhancement typically translates into a coating thickness of at least about 0.25 microns. Broadly, the coating thickness will range from between about 0.25 and 30 microns, and advantageously it will range from between about 1 and 12 microns in thickness. The coating thickness can be varied depending upon a variety of convention factors including, for example, type of workpiece being cut, cutting conditions (e.g., wet or dry, infeed rate, depth of cut, etc.), and like factors.

At least the portion of the cBN compact surface in contact with the workpiece being machined should be coated and preferably substantially all of the exterior surfaces of the cBN compact should be coated. Uncoated and unevenly coated cBN compacts will reduce tool performance compared to a completely coated cBN compact; yet, even such incompletely coated cBN compacts are expected to out-perform a comparable uncoated cBN compact. Most conventional coating techniques, such as those listed above, yield a completely coated cBN product if practiced properly.

Unlike the prior art that cites improved performance of coated high cBN compacts on ferrous alloys with low hardness (<45 Rockwell C Scale or Rc), the coated low cBN content tools disclosed herein have demonstrated extended life in used commercially in the high speed machining of hardened steels (>45 Rc). Traditionally, workpieces machined have included pinion gears, side gears, transmission shafts, axle shafts and bearings, where both continuous and interrupted cuts are seen. The inventive coated cBN compacts also will find use for such conventional workpiece machining. The novel coated cBN compacts also display efficacy in machining soft steels and nodular iron, which workpieces are not traditionally machined with cBN compacts. Thus, the present invention now will enable a variety of non-traditional workpieces to be machined with cBN compacts, as the examples will demonstrate.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by volume, unless otherwise expressly indicated. Also, all citations referred herein are expressly incorporated herein by reference.

### EXAMPLES

### Example I

In this example, high hardness, AISI-SAE grade 4340 steel (American Iron and Steel Institute-Society of Automotive Engineers) was used to measure cBN cutting tool life under the following conditions: 400 SFM cutting speed, 0.005 PR feed (inches per revolution), 0.010 inches DOC (depth of cut), dry cutting (no lubrication fluid). The cBN tool inserts used contained about 90 volume-% cBN content (Samples 1-3 representative of prior art coated and uncoated high cBN tools) or 65 volume-% CBN content (Samples 4-6) The tool inserts were tested as is, with TiC coating, or with TiN coating. Tool flank wear was the chosen criterion monitored. Flank wear represents loss of material from the tool, a measure of tool life and often results in degradation to the surface of the workpiece being machined. In this particular test, flank wear over 0.007″ represents the end of useful tool life. The results obtained are illustrated in FIG. 1 and summarized below in Table I.

TABLE I
TYPE 4340 STEEL

| | | Tool Life to |
|---|---|---|
| | | 0.007″ flank |
| | | wear |
| Sample No. | Tool Type | (min) |
| 1 | Uncoated 90% cBN | 2.8 |
| 2 | TiC Coated 90% cBN | <2 |
| 3 | TiN Coated 90% cBN | 18 |
| 4 | Uncoated 65% cBN | 30 |
| 5 | TiC Coated 65% cBN | 12 |
| 6 | TiN Coated 65% cBN | 82 |

The inventive TiN coated, 65% cBN tool substantially outperformed all other tools for machining hard steel, lasting over 80 minutes before failure (0.007″ flank wear.) Prior art uncoated tools (examples of the prior art) achieved only 3 minutes for high cBN content and 30 minutes for low cBN content. Coated high cBN tools, described in EP102843, demonstrated no more than 18 minutes of tool life. It is instructive that these coated prior art tools demonstrated less life than the normally used, uncoated low (65%) cBN coated tools. The inventive TiC coating on 65% cBN tools represented a substantial improvement over EP102843 tools achieving 12 minutes of life compared to less than 3 minute for the analogous coated prior art tool.

### Example II

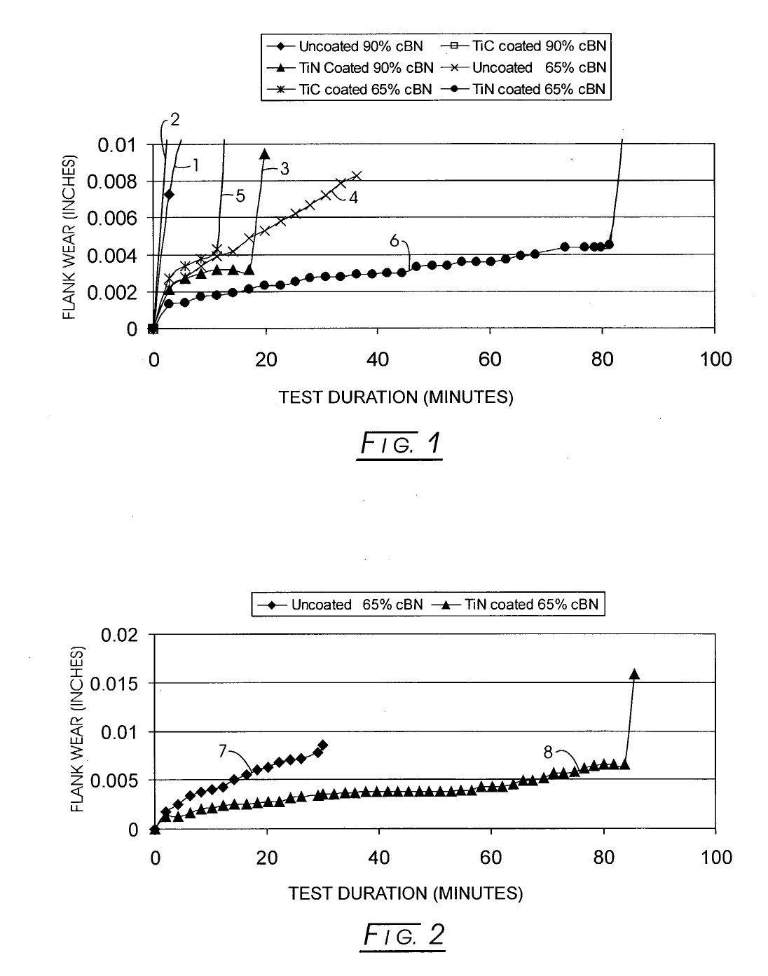

The tests reported in Example I were repeated on the same substrate under the same test conditions for prior art, uncoated 65% cBN tools, and TiN coated 65% inventive tools. These results are depicted graphically at FIG. 2 and summarized below in Table II.

TABLE II
TYPE 4340 STEEL
TOOL LIFE

| | | Tool Life to 0.007″ |
|---|---|---|
| | | Flank |
| Sample No. | Tool Type | (min) |
| 7 | Uncoated 65% cBN | 24 |
| 8 | TiN Coated 65% cBN | 84 |

Once again, the inventive tool demonstrated a life over 80 minutes, more than 4 times that of the prior art. This highly repeatable performance is highly desirable for industrial machining applications.

### Example III

In this example, AISI-SAE grade 1045 steel (HRB 98), a soft steel, was machined under the following conditions: 1,200 SFM cutting speed, 0.010 PR feed, 0.050 inches DOC, and dry cutting. A ceramic tool, Kennametal grade K090 ceramic (alumina and 30% TiC composition used for machining carbon steels, alloy steels, tool steels, and stainless steels to 60 RC) was compared to the inventive TiN coated 65% cBN tool. These results are depicted graphically in FIG. 3 and summarized in Table III below.

TABLE III
TYPE 1045 STEEL
TOOL LIFE

| | | Time to 0.007″ Flank |
|---|---|---|
| | | Wear Failure |
| Sample No. | Tool Type | (min) |
| 9 | Ceramic Tool | 7.9 |
| 10 | TiN Coating 65% cBN | >11.8 |

The coated cBN tool performance, if extrapolated, would be 4 times longer than the conventional ceramic tool. CBN tool are rarely used on soft steel workpieces, because their life has been far too short. The inventive tool provides useful tool life allowing its use on a broad range of ferrous alloys.

### Example IV

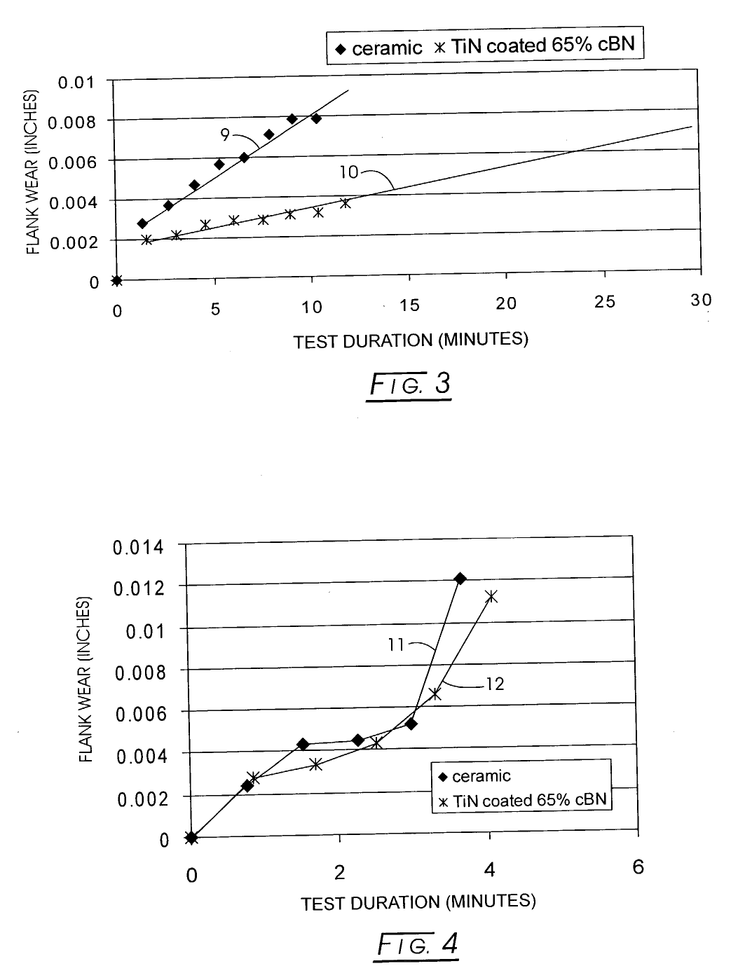

The tests on soft steel reported in Example III were repeated at an increased cutting speed of 1,600 SFM. These results are depicted graphically in FIG. 4 and summarized in Table IV below.

TABLE IV
TYPE 1045 STEEL
TOOL LIFE

| | | Time To failure 0.007″ |
|---|---|---|
| | | Flank Wear |
| Sample No. | Tool Type | (min) |
| 11 | Comparative Ceramic | 3.1 |
| | Tool | |
| 12 | TiN Coating on 65% | 3.4 |
| | cBN tool | |

These highly accelerated test results again demonstrate that, not only do the inventive coated low content cBN compacts effectively machine soft steels, where previously not used, but also provide longer machining times than a conventional alumina/TiC tool.

We claim:

1. A cutting tool comprising a polycrystalline cubic boron nitride (cBN) cutting tool containing less than 70 volume-% cBN and being coated with a layer of hard refractory material which:
(a) forms a stable chemical bond with cBN,
(b) is inert to ferrous metals,
(c) will not promote back-conversion of cBN, and
(d) will form a continuous coating on cBN under conditions which are not detrimental to cBN.

2. The cutting tool of claim 1, wherein said hard refractory material is one or more of a boride, carbide, nitride, or silicide of a metal, or alloys thereof.

3. The cutting tool of claim 2, wherein said hard refractory material is one or more of a boride of Ti, Zr, V, Ta, Cr; a carbide of Zr, Ti, V; a nitride of Cr, Ta, Ti, Si, Al; or a silicide of Mo.

4. The cutting tool of claim 3, wherein said hard refractory material is TiN.

5. The cutting tool of claim 1, wherein said layer of said hard refractory material is at least about 0.25 microns in thickness.

6. The cutting tool of claim 5, wherein said layer ranges in thickness from between about 0.25 and 30 microns.

7. The cutting tool of claim 6, wherein said layer ranges in thickness from between about 1 and 12 microns.

8. The cutting tool of claim 1, wherein said layer of said hard refractory material was applied by a technique selected from chemical vapor deposition, plasma activated vapor deposition, sputtering techniques, and vacuum plating.

9. The cutting tool of claim 1, wherein the cBN content of said cutting tool ranges from between about 30 volume-% up to 70 volume-%.

10. A method for improving the cutting performance of a polycrystalline cubic boron nitride (cBN) cutting tool used in cutting ferrous materials, which comprises the steps of:
(a) restricting the cBN cutting tool to contain less than 70 volume-% cBN; and
(b) coating said cBN cutting tool with a layer of hard refractory material which:
(1) forms a stable chemical bond with cBN,
(2) is inert to ferrous metals,
(3) will not promote back-conversion of cBN, and
(4) will form a continuous coating on cBN under conditions which are not detrimental to cBN.

11. The method of claim 10, wherein said cBN cutting tool is coated with said hard refractory material which is one or more of a boride, carbide, nitride, or silicide of a transition metal, or alloys thereof.

12. The method of claim 11, wherein said cBN cutting tool is coated with said hard refractory material which is one or more of a boride of Ti, Zr, V, Ta, Cr; a carbide of Zr, Ti, V; a nitride of Cr, Ta, Ti, Si, Al; and a silicide of Mo.

13. The method of claim 12, wherein said cutting tool is coated with TiN.

14. The method of claim 10, wherein said cBN cutting tool is coated with a layer of said hard refractory material which is at least about 0.25 microns in thickness.

15. The method of claim 14, wherein said cBN cutting tool is coated with a layer of said hard refractory material which ranges in thickness from between about 0.25 and 30 microns.

16. The method of claim 15, wherein said cBN cutting tool is coated with a layer of said hard refractory material which ranges in thickness from between about 1 and 12 microns.

17. The method of claim 10, wherein step (b) is selected from chemical vapor deposition, plasma activated vapor deposition, sputtering techniques, and vacuum plating.

18. The method of claim 10, wherein said cBN cutting tool is restricted to a cBN content ranging from between about 30 volume-% up to 70 volume-%.

19. The method of claim 10, wherein said ferrous material comprises a hardened steel having a Rockwell C Scale hardness of greater than 45.

20. The method of claim 10, wherein ferrous material is a soft steel or nodular iron.
